(19) United States
(12) Patent Application Publication
(10) Pub. No.: US 2005/0216521 A1
(43) Pub. Date: Sep. 29, 2005

(54) Apparatus and method for printing a file while bypassing the file's native application program

(76) Inventor: Sivakumar Coramutla, North Brunswick, NJ (US)

Correspondence Address: CAHN & SAMUELS LLP, 2000 P STREET NW, SUITE 200, WASHINGTON, DC, 20036, US

(21) Appl. No.: 11/024,224

(22) Filed: Dec. 29, 2004

Related U.S. Application Data
(60) Provisional application No. 60/532,637, filed on Dec. 29, 2003.

(51) Int. Cl. G06F 17/30

(52) U.S. Cl. 707/200

(57) ABSTRACT

The present invention relates to an automated system for processing a file over a computer network. The automated system for processing the file preferably includes a client computer adapted to communicate with a server computer adapted to communicate with a database including at least one file in a first file format accessible by the computer and a printing process module including computer readable instructions for allowing a copy of the file to be directly printed independently of being accessed by an application program associated with the file. In addition to directly printing a document, in at least one embodiment, the file copy can also be directly transmitted via facsimile and/or electronic mail without accessing the copy via its associated application program. The invention can allow for speedier printing, emailing, or facsimile, as the application program is not activated.

This application claims the benefit of U.S. provisional application Ser. No. 60/532,637, filed on Dec. 29, 2003, which is herein incorporated by reference in its entirety.

### I. FIELD OF THE INVENTION

The present invention relates generally to document processing, and more particularly to an automated system for directly printing a file without accessing the application program in which the file was created.

### II. BACKGROUND OF THE INVENTION

In many situations, it is desirable to print large numbers of files from file directories or databases. This typically requires first activating an application program associated with the file, accessing the file through the application program, and then finally printing the file. The user often does not need to edit the file or even view the file on a computer screen, for example. However, in order to print the files, the user is still required to activate the native application program for files. In such a situation, activating the associated application program can result in wasted time and unnecessary utilization of computer resources such as memory and processor capacity. This is particularly true if the user is printing a number of files having different native application programs.

Alternatively, instead of the user activating the file's native application program, the file may be printed via a file management utility. In such a situation, however, the file management utility activates the application program and accesses the file before printing of the file occurs. As a result, problems similar to those identified above can be experienced.

In light of the foregoing, what is needed is a method and apparatus for printing a file independently of accessing the file with the file's native application program.

### III. SUMMARY OF THE INVENTION

It is an object of the present invention to provide an apparatus accelerated print operations.

It is a further object of the invention to provide an apparatus and method for printing files without activating the file's native application program.

It is still a further object of the invention to conserve system resources during printing operations.

These and other objects may be realized by a computer implemented apparatus for printing files having a first module that retrieves a file from a document database responsive to reception of a file identifier. A second module is provided that converts the file from a first format to a native application file format for the file and transmits a file URL for the file. A third module is provided that receives the file URL from the second module and, responsive to a request, transmits a print task to a printer to print the file corresponding to the file URL without activating the file's native application program.

### IV. BRIEF DESCRIPTION OF THE DRAWINGS

Like reference numerals in the figures represent and refer to the same element or function throughout.

FIG. 1 illustrates general flow diagram in accordance with the invention.

FIG. 2 is a flow chart for the search of module of the present invention.

FIG. 3 query builder graphical user interface in accordance with an aspect of the invention.

FIG. 4 is graphical user interface showing a search result list in accordance with an aspect of the invention.

FIG. 5 is flow diagram for a print module in accordance with the invention.

### V. DETAILED DESCRIPTION OF THE DRAWINGS

The present invention preferably includes an apparatus and method for printing a file while bypassing the file's native application program. In accordance with certain aspects of the invention, the apparatus for printing the file in accordance with the invention may be implemented on a computer and is preferably used in an environment where the computer is in communication with a document database. The invention may be realized as a method and/or an apparatus. More particularly, the invention may be realized as a set of program code instructions stored on a computer usable medium, a set of program code instructions embodied in a computer readable transmission medium, and a processor and/or computing device configured as described herein.

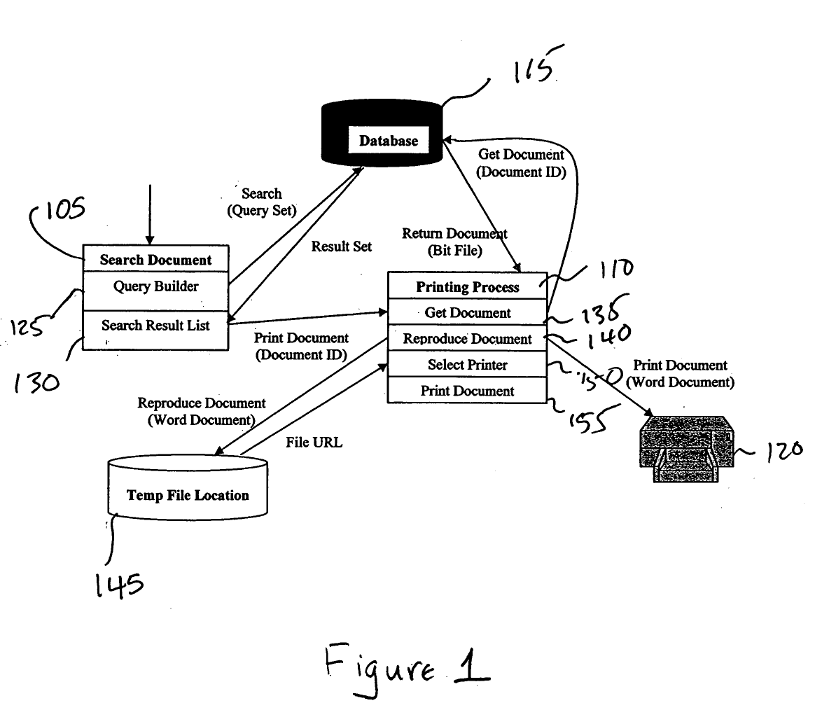

FIG. 1 is a flow diagram illustrating a general overview of the invention. As illustrated, in an exemplary embodiment, the invention includes a search module 105 and a print module 110. Both search module 105 and print module 110 directly communicate with document database 115. The print module is further in communication with one or more printers 120. Search module 105 identifies documents responsive to user requests and print module 110 transmits a print task directly to printer 120 to print one or more of the identified documents responsive to a user request without activating the document's native application program. As used herein, the term native application program refers to the application program in which the document or file was first created. The terms “file(s)” and document(s) are used herein as being interchangeable terms.

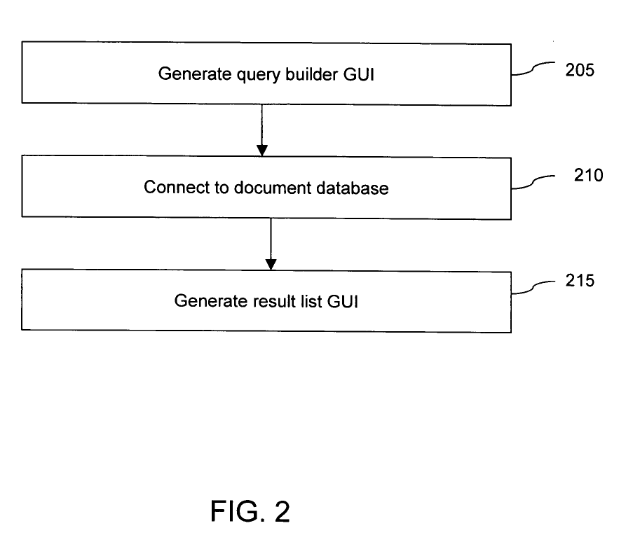

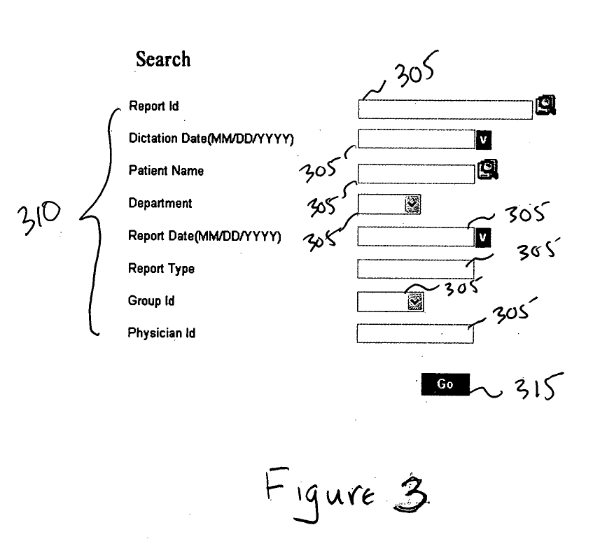

FIG. 2 illustrates a flow chart for search module 105 in accordance with an aspect of the invention. Search module 105 includes query builder function 125 and search result list function 130. In step 205, in order to assist a user in initiating a query, a query building user interface or GUI is generated. An exemplary user interface is illustrated in FIG. 3. The GUI preferably includes a plurality of data inputs 305, e.g. dialog boxes, radio buttons and the like, where each data input corresponds to an associated data field 310 of document database 115. The exemplary user interface includes data inputs 305 in the form of dialog boxes. The user may then generate the query by populating the data fields with search criteria.

In step 210, after the query has been built, search module 105 establishes a connection to document database 115. In at least one embodiment, when a user clicks on a “search” button 315, the search query built in step 205 is transmitted to document database 115. Document database 115 receives the query, conducts a search and returns a search result set to search module 105.

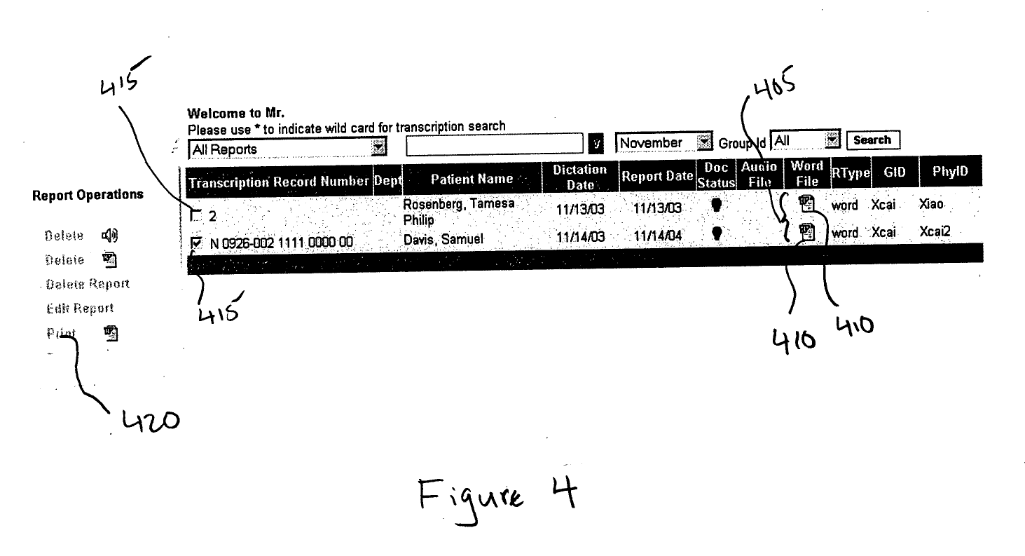

In step 215, a GUI including the search result list is preferably generated. In at least one embodiment, the search results list comprises a plurality of file links. These links may be selected by a user in a manner known to those of skill in the art. An exemplary GUI of the search result list is illustrated in FIG. 4 including search result list 405 comprising one or more file links 410, data inputs 415 for selecting individual files from among the search result list, and a print command icon 420. By populating data inputs 415, the user can select the documents that it desires to be printed.

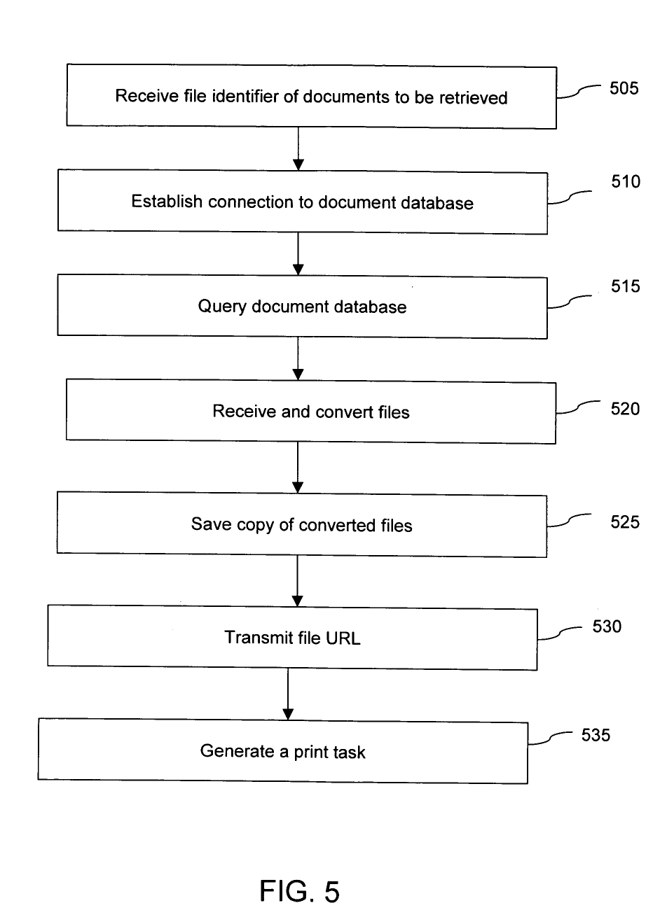

FIG. 5 illustrates a flow diagram for print module 110. Print module 110 is called when the user activates print icon 420. In step 505, a “get document” routine 135 of print module 110 receives a file identifier of the document(s) to be retrieved. In step 510, print module 110 connects to document database 115 in preparation for document query.

In step 515, document database 115 is queried to retrieve documents associated with the file identifiers. As documents stored in document database 115 are typically in bit file format and not viewable by a user, it is desirable to convert those files to user-viewable format. Accordingly, in step 520, the reproduce document routine 140 of print module 110 receives the files in bit file format and transfers or converts the bit files to a user viewable, native application file format. The native application file format may be any desired application file format such as a word processing file format, a spread sheet file format, a database file format, or any other application file format employed by the user.

In step 525, the reproduce document routine 140 saves a copy the converted files in temporary storage such as temporary file location 145 of FIG. 1. In keeping with the invention, step 525 need not be performed in all embodiments. Where step 525 is not performed, rather than creating a copy of the document, the document itself is stored in a user-viewable native application file format.

In step 530, reproduce document routine 140 transmits the file Uniform Resource Locator (URL) of the file copy, that is, the document stored on the secondary storage location, of file itself if no copy is made, to print document routine 155. In step 535, responsive to receipt of the file URL, print document routine 155 generates a print task and transmits the print task directly to printer 120 for execution. In keeping with an aspect of the invention, print document routine 155 generates and transmits the print task without activating and while bypassing the file's native application program. Accordingly, the print operation may be performed independent of or without activating the file's native application program. As a result, printing speed is increased. In addition system resources are conserved through, for example, reduction in CPU and memory usage.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings. Although Microsoft Word® documents were referred to herein, it should be noted that such references were used for explanatory purposes. Other types of documents can also be used, for example, Adobe Acrobat® documents, databse documents (e.g. Microsoft Access), spreadsheet documents, (e.g. Microsoft Excel), presentation software documents (e.g. Microsoft Powerpoint), etc.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

1. A computer implemented apparatus for printing files comprising:
a first module that retrieves a file from a document database responsive to reception of a file identifier;
a second module that converts the file from a first format to a native application file format for the file and transmits a file URL for the file; and
a third module that receives the file URL from the second module and, responsive to a request, transmits a print task to a printer to print the file corresponding to the file URL without activating a native application program in which the file was created.

2. The apparatus of claim 1 wherein the first module receives a file identifier and queries the document database for the file corresponding to the file identifier.

3. The apparatus of claim 1 wherein the first file format is a bit file format.

4. The apparatus of claim 1 wherein the second module stores converted file in a temporary storage location.

5. The apparatus of claim 1 further comprising a printer selection module that generates a list of printers that are connected to the computer, that receives a selection of a printer from a user and that transmits an identifier for the selected printer to said third module, said third module sending the print task to the selected printer.

6. The apparatus of claim 1 further comprising a search module that generates a user interface including query having a plurality of unpopulated data fields, that upon user population of the data fields and upon user request transmits the query to the document database to conduct a search for documents based on the query and that generates a user interface including a list of documents responsive to the query.

7. A method in a computer of saving files comprising:
retrieving a file from a document database responsive to reception of a file identifier;
converting the file from a first format to a native application file format
transmitting a file URL for the file to a printer
generating a print task for the file corresponding to the file URL and transmitting the print task to a printer without activating a native application program in which the file was created.

8. A computer-readable medium having computer executable instructions for performing the method of claim 7.

9. A data signal embodied in a transmission medium readable by a computing system and encoding instructions for executing the method recited in claim 7.
